(19) United States
(12) Patent Application Publication
(10) Pub. No.: US 2024/0387904 A1
(43) Pub. Date: Nov. 21, 2024

(54) TEMPERATURE CONTROL ARRANGEMENT AND METHOD OF MANUFACTURING A TEMPERATURE CONTROL ARRANGEMENT

(71) Applicant: Benteler Automobiltechnik GmbH, Paderborn (DE)

(72) Inventors: Conrad Frischkorn, Paderborn (DE); Lars Landermann, Herford (DE)

(73) Assignee: Benteler Automobiltechnik GmbH, Paderborn (DE)

(21) Appl. No.: 18/666,324

(22) Filed: May 16, 2024

(30) Foreign Application Priority Data
May 17, 2023 (EP) 23173842.8

(51) Int. Cl. H01M 10/6556; B60L 50/64; B60L 58/24; H01M 10/617; H01M 10/625; H01M 10/656

(52) U.S. Cl. CPC H01M 10/6556; H01M 10/617; H01M 10/625; H01M 10/656; B60L 50/64; B60L 58/24; H01M 2220/20

(57) ABSTRACT

A temperature control arrangement includes a battery housing for accommodating battery modules for an electrically powered vehicle, and a temperature control plate which includes a fluid channel having a channel opening and which includes a connection opening. The temperature control is welded circumferentially to the battery housing via a first weld seam which is located on a side of the temperature control plate facing away from the battery housing. A cap is welded to the temperature control plate in a fluid-tight manner via a second weld seam such that the first weld seam and the second weld seam intersect. The cap partially covers the first weld seam and includes an overflow channel to connect the channel opening and the connection opening in a fluid-conducting manner, with the temperature control plate and the cap lying opposite to one another at least in one section in the overflow channel.

### CROSS-REFERENCES TO RELATED APPLICATIONS

This application claims the priority of European Patent Application, Ser. No. 23/173,842.8, filed May 17, 2023, pursuant to 35 U.S.C. 119 (a)-(d), the disclosure of which is incorporated herein by reference in its entirety as if fully set forth herein.

### BACKGROUND OF THE INVENTION

The present invention relates to a temperature control arrangement and to a method of manufacturing a temperature control arrangement.

The following discussion of related art is provided to assist the reader in understanding the advantages of the invention, and is not to be construed as an admission that this related art is prior art to this invention.

Electrically powered vehicles usually have battery modules to provide the required electrical energy. These battery modules are normally arranged in a battery housing, which is located between the axles of the vehicle. In order to make optimum use of the energy stored in the battery modules, the battery modules must be kept within defined temperature ranges. Under high loads, the heat generated in the battery modules must be dissipated to prevent the battery from overheating. Heating may also be needed at low outside temperatures or in preparation for charging the battery modules.

In order to ensure appropriate temperature control of the battery modules, one approach involves connection of temperature control plates to the battery housing. The temperature control plates have fluid channels through which a temperature control fluid flows and is able to absorb heat from the battery housing and thus from the battery modules arranged in the battery housing or release heat to them. A conventional design of the fluid supply of the temperature control arrangements involves a connection element which is connected to a channel opening of the fluid channel and to a fluid guidance of the motor vehicle. However, the presence of such a connection element has two significant disadvantages. Firstly, the coupling of the connection element to the temperature control plate is complex and secondly, the production of the connecting element is costly due to its complexity.

It would therefore be desirable and advantageous to provide an improved temperature control arrangement and improved method for its manufacture to obviate prior art shortcomings.

### SUMMARY OF THE INVENTION

According to one aspect of the present invention, a temperature control arrangement includes a battery housing designed to accommodate battery modules for an electrically powered vehicle, a temperature control plate designed to include a fluid channel having a channel opening and to include a connection opening, the temperature control being welded circumferentially to the battery housing via a first weld seam which is located on a side of the temperature control plate facing away from the battery housing, and a cap welded to the temperature control plate in a fluid-tight manner via a second weld seam such that the first weld seam and the second weld seam intersect, the cap being designed to partially cover the first weld seam and including an overflow channel to connect the channel opening and the connection opening in a fluid-conducting manner, with the temperature control plate and the cap lying opposite to one another at least in one section in the overflow channel.

It is to be understood that the term “battery housing” is used in a generic sense and is equally applicable to battery elements and/or battery cells.

The temperature control arrangement includes a temperature control plate that is connected to the battery housing. The battery modules arranged in the battery housing can be tempered, i.e. cooled or heated, via the temperature control plate. For this purpose, the temperature control plate has at least one fluid channel, with the fluid channel having at least one channel opening through which a temperature control fluid can be introduced or discharged into the fluid channel.

The temperature control plate includes at least one connection opening. The temperature control plate can be connected to a fluid guidance of the motor vehicle via the connection opening. A cap is joined to the temperature control plate, with the cap connecting the channel opening and the connection opening in a fluid-conducting manner via formation of an overflow channel. The temperature control fluid provided by the fluid guidance can thus flow through the connection opening, the overflow channel and the channel opening into the fluid channel. A reverse flow direction is also possible.

The temperature control plate and the cap can lie opposite each other, at least in one section, in the overflow channel. The shape of the overflow channel is thus essentially dependent on the design of the cap. The cap, and thus the overflow channel, can therefore be matched to specific structural or flow requirements without the need to adapt the other components of the temperature control plate. A temperature control arrangement according to the invention thus offers a high degree of flexibility with regard to the design and dimensioning of the fluid supply and fluid discharge of the temperature control plate.

The cap can advantageously be hot-formed or cold-formed in one piece from an aluminum or special steel sheet. It is therefore a simple and inexpensive component to manufacture. The cap may advantageously be shaped in such a way that the outer contour of the cap rests seamlessly on the temperature control plate, i.e. without forming a gap, when the cap is arranged on the temperature control plate. This simplifies the subsequent joining process and ensures a fluid-tight fit of the cap on the temperature control plate.

Advantageously, the cap can have a flattened area on its outer contour. The flattened area provides a suitable joining surface for welding the cap to the tempering plate.

The temperature control plate and the battery housing can advantageously be made of aluminum and/or special steel.

According to another advantageous feature of the invention, the fluid channel can be bounded by the battery housing. This has the advantage that the temperature control fluid flowing through the fluid channel comes into direct contact with the battery housing. This ensures optimum heat transfer between the battery housing and the temperature control fluid. Another advantage is that the temperature control plate can be formed from a single workpiece or metal sheet. The fluid channels of the temperature control plate can be formed using a hot forming or cold forming process.

According to another advantageous feature of the invention, the temperature control plate can be designed as an at least partially double-walled temperature control plate with an upper plate and a lower plate. The fluid channel can hereby be bounded by the upper plate and the lower plate, and the channel opening may advantageously be formed in the upper plate. The lower plate of the temperature control plate can rest against the battery housing. This configuration has the advantage that the temperature control fluid does not directly contact the battery housing. Heat is therefore transferred between the lower plate and the battery housing. This can be advantageous, for example, when the surface of the battery housing is not designed for contact with the temperature control fluid.

The temperature control plate is circumferentially welded to the battery housing via a first weld seam. The first weld seam is located on the side of the temperature control plate facing away from the battery housing. A secure hold between the temperature control plate and the battery housing can be ensured by a corresponding welded connection. It is also a cost-effective joining process.

The cap covers the first weld seam, with the cap being welded to the temperature control plate in a fluid-tight manner via a second weld seam. As a result, the first weld seam and the second weld seam intersect. The fact that the temperature control plate is welded to the battery housing before the cap is placed on the temperature control plate has the advantage that a secure connection between the battery housing and the temperature control plate is also ensured in the area of the cap. The outer contour of the cap can also have a recess in such a way that any bead of the first weld seam protruding beyond the temperature control plate lies in the recess when the cap is positioned on the temperature control plate.

According to another advantageous feature of the invention, the temperature control plate can include a projection which protrudes beyond the battery housing, with the connection opening being arranged within the projection. This allows the fluid guidance to be connected to the connection opening without increasing the structural height of the temperature control arrangement.

For this purpose, a connection piece may advantageously be connected to the connection opening. The connection piece is used to connect the connection opening to the fluid guidance of the motor vehicle. The connection piece may advantageously extend transversely to the side of the temperature control plate facing the battery housing. In contrast to conventional approaches, the connection piece therefore does not protrude beyond the battery housing, but runs essentially parallel to a narrow side of the battery housing, starting from the connection opening. The installation height of the temperature control arrangement is therefore not further increased by the presence of the connection piece or the fluid guidance connected to it. As a result, this configuration provides a temperature control arrangement with a lowest possible structural height.

According to another advantageous feature of the invention, the temperature control plate can include two connection openings, with one of the two connection openings forming a fluid inlet and another one of the two connection openings forming a fluid outlet. Advantageously, the fluid channel can include two channel openings, with one of the two channel openings forming a fluid inlet and another one of the two channel openings forming a fluid outlet. In this configuration, the temperature control arrangement can have two caps, with one of the two caps fluidically connecting the connection opening designed as fluid inlet with the channel opening designed as fluid inlet, whereas the other cap fluidically connects the connection opening designed as fluid outlet with the channel opening designed as fluid outlet. The temperature control fluid can thus flow into the overflow channel through the connection flow designed as fluid inlet and enter the fluid channel through the channel opening designed as fluid inlet. After temperature control of the battery housing, the heated or cooled temperature control fluid flows through the channel opening designed as fluid outlet into the second overflow channel formed by the temperature control plate and the second cap and from there through the connection opening designed as fluid outlet back into the fluid guidance of the vehicle. A closed fluid circuit is thus formed as a result.

When the temperature control arrangement has two caps, the two caps can be integrally joined. This simplifies the arrangement of the caps on one hand and the joining process with the temperature control plate on the other hand.

Both the fluid channel and the cap have a maximum height. Advantageously, the maximum height of the cap can be less than or equal to the maximum height of the fluid channel. As a result, the cap does not additionally increase the height of the temperature control arrangement.

According to another advantageous feature of the invention, the fluid channel can have a bulge anteriorly of the channel opening. This bulge advantageously represents the maximum structural height of the fluid channel. Starting from the point of maximum height, the structural height advantageously decreases linearly until the fluid channel ends or the temperature control plate comes into contact with the battery housing. Consequently, a chamfered area of the fluid channel is formed. The channel opening can advantageously be located in this chamfered area of the fluid channel. This has proven to be particularly advantageous for fluid guidance as well as for joining the cap.

The angle between the chamfered area of the fluid channel and the battery housing may advantageously range between 5° and 30°. Currently preferred is an angle between 15° and 25°.

According to another aspect of the invention, a method of manufacturing a temperature control arrangement includes arranging a temperature control plate on a battery housing designed to accommodate battery modules for an electrically powered vehicle, circumferentially welding the temperature control plate to the battery housing via a first weld seam located on a side of the temperature control plate facing away from the battery housing, arranging a cap on the temperature control plate such as to partially cover the first weld seam and to fluidically connect a channel opening of a fluid channel of the temperature control plate and a connection opening of the temperature control plate via an overflow channel, and circumferentially welding the cap to the temperature control plate in a fluid-tight manner via a second weld seam in such a way that the first weld seam and the second weld seam intersect.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective view of a temperature control arrangement according to the invention;

FIG. 2 is a sectional view of the temperature control arrangement; and

FIG. 3 is a representation of a variant of a cap.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

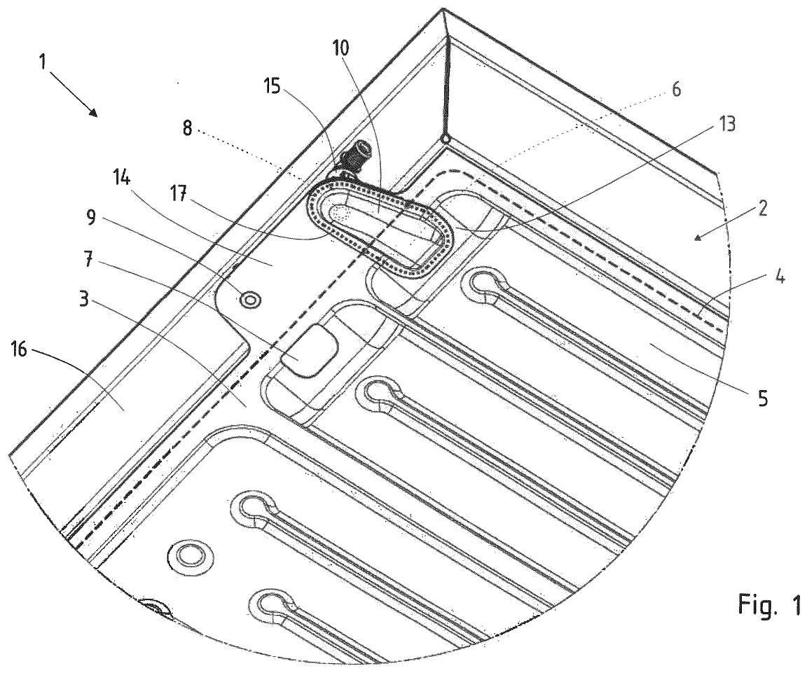

Turning now to the drawing, and in particular to FIG. 1, there is shown a perspective view of a temperature control arrangement according to the invention, generally designated by reference numeral 1 and including a battery housing 2 for holding battery modules for an electrically powered vehicle, not shown here. The battery housing 2 is arranged underneath a vehicle interior and between the axles of the electrically powered vehicle.

The temperature control arrangement 1 further includes a temperature control plate 3. The temperature control plate 3 is circumferentially welded to the side of the battery housing 2 facing away from the vehicle, i.e. the underside of the battery housing 2 via a first weld seam 4. The first weld seam 4 is located on the side of the temperature control plate 3 facing away from the battery housing 2.

The temperature control plate 3 has a fluid channel 5, which has a channel opening 6 to form a fluid inlet, and a channel opening 7 to form a fluid outlet.

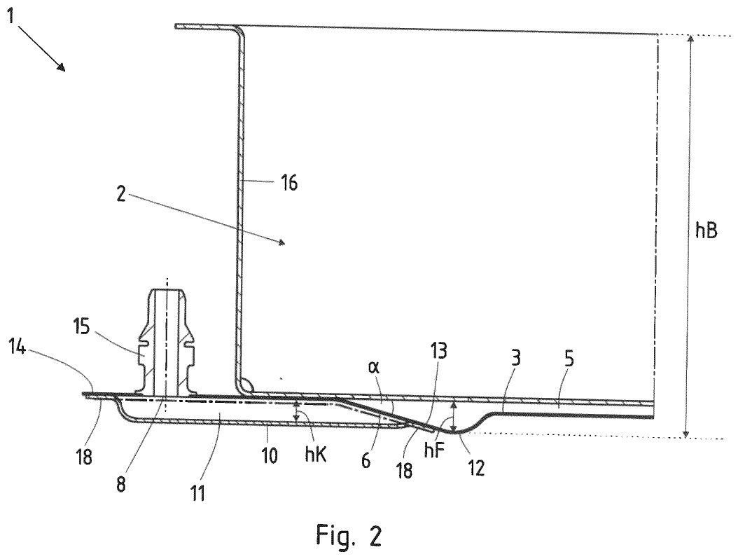

The temperature control plate 3 further has a connection opening 8 to form a fluid inlet and a connection opening 9 to form a fluid outlet. A cap 10 is joined to the temperature control plate 3 and connects the channel opening 6 as fluid inlet, and the connection opening 8 as fluid inlet, in a fluid-conducting manner via an overflow channel 11 which is formed by the cap 10 and the temperature control plate 3 and shown in greater detail in FIG. 2. For ease of illustration, FIG. 1 shows the arrangement of a cap 10 only at the inlet openings 6, 8 and not at the outlet openings 7, 9.

The temperature control fluid, which is not shown in the figures, can flow into the overflow channel 11 through the connection opening 8 as fluid inlet, and enter the fluid channel 5 through the channel opening 6 as fluid inlet. After the temperature control of the battery housing 2, the heated or cooled temperature control fluid flows through the channel opening 7 as fluid outlet into a second overflow channel formed by the temperature control plate 3 and an unillustrated second cap and from there through the connection opening 9 as fluid outlet back into the fluid guidance of the vehicle. As a result, a closed fluid circuit is thus formed for cooling or heating the battery modules in the battery housing 2.

The shape of the overflow channel 11 is essentially determined by the design of the cap 10. The cap 10, and thus the overflow channel 11, can therefore be matched to specific structural or flow requirements without the need to adapt the other components of the temperature control plate 3. The temperature control arrangement 1 thus offers a high degree of flexibility with regard to the design and dimensioning of the fluid supply of the temperature control plate 3.

The fluid channel 5 has a bulge 12 anteriorly of the respective channel opening 6, 7. In this bulge 12, the fluid channel 5 has its maximum height hF. Starting from the point of maximum height hF, the height of the fluid channel 5 decreases linearly until the fluid channel 5 ends or the temperature control plate 3 comes into contact with the battery housing 2. As a consequence, a chamfered area 13 is formed. The channel openings 6, 7 are arranged in the chamfered area 13 of the fluid channel 5. This has proven to be particularly advantageous for fluid guidance as well as for joining the cap 10.

An angle α between 5° and 30° is advantageously formed between the chamfered area 13 of the fluid channel 5 and the battery housing 2. Currently preferred is an angle α between 15° and 25° between the chamfered area 13 of the fluid channel 5 and the battery housing 2.

The fluid channel 5 is bounded by the battery housing 2. The temperature control fluid flowing in the fluid channel 5 and not shown in greater detail therefore comes into direct contact with the battery housing 2. This ensures optimum heat transfer between the temperature control fluid and the battery housing 2.

FIG. 2 further shows that the temperature control plate 3 and the cap 10 lie opposite each other in the overflow channel 11 at least in one section. The temperature control plate 3 seals the fluid channel 5 laterally and, with reference to FIG. 2, downwards. The top of the fluid channel 5 is covered by the battery housing 2. On the side of the chamfered area 13 facing away from the fluid channel 5, the temperature control plate 3 rests upon the battery housing 2 and is welded to the battery housing 2. The temperature control plate 3 covers the top of the overflow channel 11 formed by the cap 10. Relative to the flowing temperature control fluid, the temperature control plate 3 is thus shifted from the topside of the overflow channel 11 to the bottom side of the fluid channel 5.

The temperature control plate 3 has a projection 14 that protrudes beyond the battery housing 2. Both connection openings 8, 9 are arranged within the projection 14.

The connection openings 8, 9 are each connected to a connection piece 15. The connection pieces 15 are connected to an unillustrated fluid guidance of the motor vehicle. Each of the connection pieces 15 extends transversely to the side of the temperature control plate 3 facing the battery housing 2. In the exemplified embodiment shown here, the connection pieces 15 extend essentially parallel to a narrow side 16 of the battery housing 2. The temperature control arrangement 1 thus offers the further advantage that the design of the fluid supply concept and fluid discharge concept does not additionally increase the structural height hB of the temperature control arrangement 1.

The cap 10 partially covers the first weld seam 4, with the cap 10 being welded to the temperature control plate 3 in a fluid-tight manner via a second weld seam 17. The first weld seam 4 and the second weld seam 17 intersect. In FIG. 1, the first weld seam 4 is visible through the cap 10 for reasons of illustration. By subsequently positioning the cap 10 on the first weld seam 4, a secure connection of the temperature control plate 3 to the battery housing 2 can also be ensured in the area of the overflow channel 11.

The cap 10 has a flattened portion 18 on its outer contour. The flattened portion 18 provides a suitable joining surface for welding the cap 10 to the temperature control plate 3.

The fluid channel 5 has a maximum height hF and the cap 10 has a maximum height hK. In the exemplified embodiment shown here, the maximum height hK of the cap 10 is smaller than the maximum height hF of the fluid channel 5. This also has the advantage that the structural height hB of the temperature control arrangement 1 is not additionally increased.

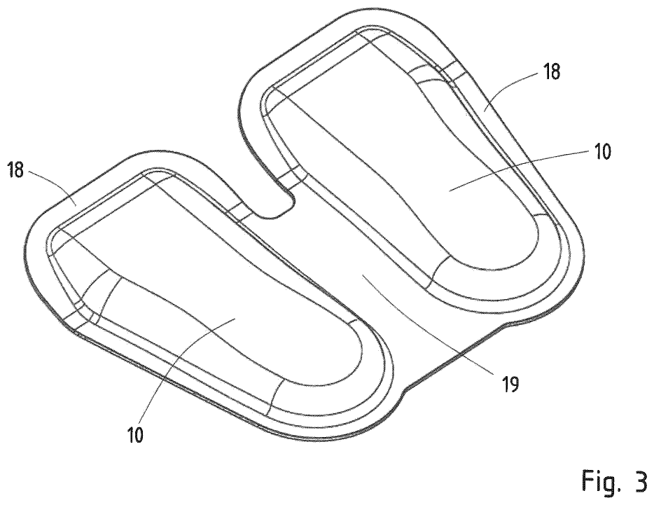

When the temperature control arrangement 1 includes two caps 10, these two caps 10 can be integrally joined or designed as one piece. A corresponding configuration is shown in FIG. 3. The two caps 10 are formed in one piece and connected to each other via a connecting web 19. This simplifies the arrangement of the caps 10 on the temperature control plate 3 on one hand and the joining process of the caps 10 to the temperature control plate 3 on the other hand.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A temperature control arrangement, comprising:
a battery housing designed to accommodate battery modules for an electrically powered vehicle;
a temperature control plate designed to include a fluid channel which has a channel opening and to include a connection opening, said temperature control plate being welded circumferentially to the battery housing via a first weld seam which is located on a side of the temperature control plate facing away from the battery housing; and
a cap welded to the temperature control plate in a fluid-tight manner via a second weld seam such that the first weld seam and the second weld seam intersect, said cap being designed to partially cover the first weld seam and including an overflow channel to connect the channel opening and the connection opening in a fluid-conducting manner, with the temperature control plate and the cap lying opposite to one another at least in one section in the overflow channel.

2. The temperature control arrangement of claim 1, wherein the fluid channel is bounded by the battery housing.

3. The temperature control arrangement of claim 1, wherein the temperature control plate is designed as an at least partially double-walled temperature control plate with an upper plate and a lower plate, the fluid channel being bounded by the upper plate and the lower plate and the channel opening being formed in the upper plate.

4. The temperature control arrangement of claim 1, wherein the temperature control plate includes a projection which protrudes beyond the battery housing, with the connection opening being arranged within the projection.

5. The temperature control arrangement of claim 1, wherein the temperature control plate includes two of said connection opening, with one of the two connection openings forming a fluid inlet and another one of the two connection openings forming a fluid outlet.

6. The temperature control arrangement of claim 5, wherein the fluid channel includes two of said channel opening, with one of the two channel openings forming a fluid inlet and another one of the two channel openings forming a fluid outlet.

7. The temperature control arrangement of claim 6, wherein the temperature control arrangement includes two of said cap, with one of the two caps fluidically connecting the one of the two connection openings to the one of the two channel openings and the other one of the two caps fluidically connecting the other one of the two connection openings to the other one of the two channel openings.

8. The temperature control arrangement of claim 7, wherein the two caps are integrally joined.

9. The temperature control arrangement of claim 1, further comprising a connection piece connected to the connection opening.

10. The temperature control arrangement of claim 9, wherein the connecting piece extends transversely to a side of the temperature control plate facing the battery housing.

11. The temperature control arrangement of claim 1, wherein the fluid channel has a maximum overall height and the cap has a maximum overall height which is less than or equal to the maximum overall height of the fluid channel.

12. A method of manufacturing a temperature control arrangement, the method comprising:
arranging a temperature control plate on a battery housing designed to accommodate battery modules for an electrically powered vehicle;
circumferentially welding the temperature control plate to the battery housing via a first weld seam located on a side of the temperature control plate facing away from the battery housing;
arranging a cap on the temperature control plate such as to partially cover the first weld seam and to fluidically connect a channel opening of a fluid channel of the temperature control plate and a connection opening of the temperature control plate via an overflow channel; and
circumferentially welding the cap to the temperature control plate in a fluid-tight manner via a second weld seam in such a way that the first weld seam and the second weld seam intersect.

13. The method of claim 12, further comprising bounding the fluid channel by the battery housing.

14. The method of claim 12, further comprising:
designing the temperature control plate as an at least partially double-walled temperature control plate with an upper plate and a lower plate;
bounding the fluid channel by the upper plate and the lower plate; and
forming the channel opening in the upper plate.

15. The method of claim 12, further comprising:
forming the temperature control plate with a projection to protrude beyond the battery housing; and
arranging the connection opening within the projection.

16. The method of claim 12, further comprising designing the temperature control plate with two of said connection opening, with one of the two connection openings forming a fluid inlet and another one of the two connection openings forming a fluid outlet.

17. The method of claim 16, further comprising designing the fluid channel with two of said channel opening, with one of the two channel openings forming a fluid inlet and another one of the two channel openings forming a fluid outlet.

18. The method of claim 17, further comprising arranging two of said cap on the temperature control plate, with one of the two caps fluidically connecting the one of the two connection openings to the one of the two channel openings and the other one of the two caps fluidically connecting the other one of the two connection openings to the other one of the two channel openings.

19. The method of claim 18, further comprising integrally joining the two caps.

20. The method of claim 12, further comprising connecting a connection piece to the connection opening, with the connecting piece extending transversely to a side of the temperature control plate facing the battery housing.
